(19) United States
(12) Patent Application Publication
(10) Pub. No.: US 2023/0302923 A1
(43) Pub. Date: Sep. 28, 2023

(54) Method for Powering Electric Vehicle with Electrostatic and AC Electricity

(71) Applicant: Lawrence Lavern Rosier, Rolla, MO (US)

(72) Inventor: Lawrence Lavern Rosier, Rolla, MO (US)

(21) Appl. No.: 17/656,428

(22) Filed: Mar. 25, 2022

(51) Int. Cl. B60L 50/90; B60L 50/60; B60L 50/51; H02N 1/00

(52) U.S. Cl. CPC B60L 50/90; B60L 50/60; B60L 50/51; H02N 1/002; B60L 2210/42

(57) ABSTRACT

The Method uses Nikola Tesla's process for generating Electrostatic Electricity also called Cold Electricity by Tesla. A large Inverter powers the Generator where Radiant Electricity is created from high frequency high voltage Pulsed DC. A magnet is placed 90 degrees with the spark gap to remove the current (negative electrons) at the spark Gap leaving the flow of voltage. This significantly increases the voltage much more than the input voltage. Electrostatic Electricity mixes well with Regular Electricity because it is the voltage part of Regular Electricity with no current. The Frequency Transformer allows the Electrostatic and Regular Electricities to mix in separate coils.

### 1. BACKGROUND

In 1892 Nikola Tesla revealed his discovery of Radiant Electricity, a form of electrostatic electricity also called Cold Electricity by Tesla. The key element of the invention was that it created a massive amount of voltage much more than was input.

This invention is similar to other Lawrence Rosier patent applications:
“Charging an EV while Driving” Ser. No. 16/351,563 Mar. 13, 2019.

### 2. ABOUT ELECTROSTATIC ELECTRICITY

Electrostatic Electricity is not static nor is it electricity. It is pure voltage without current, it flows backward in time on one wire and does not require a circuit. It uses variable frequencies unlike regular AC 60 Hz (for this reason it will destroy a Multimeter). Electrostatic Electricity Flows on the outside of an insulated wire and will short out if incomes within one inch of metal (current flows only within an insulated wire). This makes it dangerous for electrical shock.

### 3. SUMMARY

The Method powers an Electric Vehicle using Nikola Tesla's Radiant Electricity, or Electrostatic Electricity. This invention was inspired by the fact that Tesla's Electrostatic Electricity produced more electricity than input thus violating the First and Second laws of Thermodynamics. This invention uses Electrostatic Electricity in a simple way to power an Electric Vehicle by pulling static electricity from the environment. The method is a significant cost savings, requiring no fossil fuels or batteries.

### 4. DESCRIPTION OF DRAWING

The Drawing is schematic showing the wiring connections between the various devices. All of the devices are common devices which are well known except for the Frequency Transformer and Spark Gap which can be easily made.

### 4.1 Drawing Components

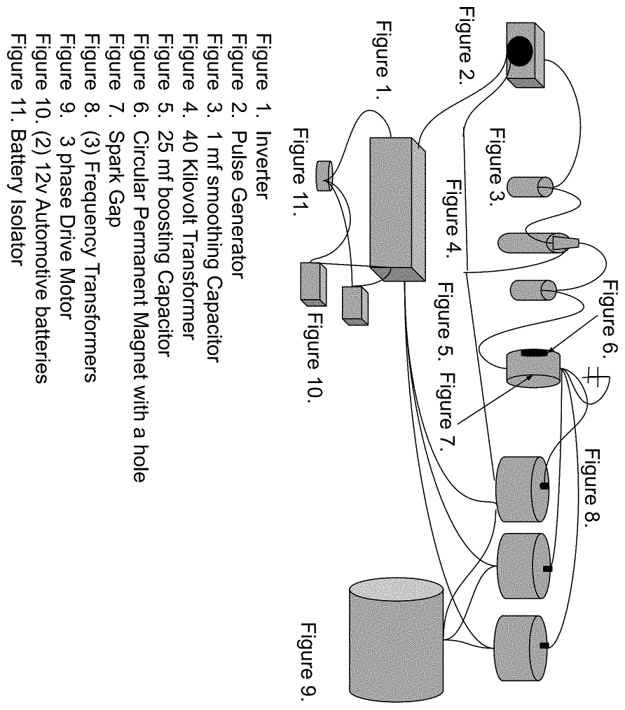

FIG. 1. Inverter converts DC to AC electricity

FIG. 2. Pulse Generator sets Frequency and duration.

FIG. 3. 1 mf Capacitor for smoothing current.

FIG. 4. Transformer 40 kilovolts for boosting power.

FIG. 5. 25 mf Capacitor for boosting power.

FIG. 6. Permanent Magnet quenches Spark Gap

FIG. 7. Spark Gap produces the Radiant Electricity.

FIG. 8. (3) Frequency Transformers, convert variable frequency to 60 Hz.

FIG. 9. 3 Phase Drive Motor.

FIG. 10. (2) 12v Automotive batteries

FIG. 11. Battery Isolator charges one battery while the other powers Inverter.

### 5. DESCRIPTION OF INVENTION

### 5.1 Preparation

The preparation begins by making sure that the two isolated 12 volt batteries are fully charged. During operation one of the 12 volt batteries is being charged while the other powers the Inverter (FIG. 1.).

### 5.2 Operation

The Pulse Generator (FIG. 2.), powered by the inverter, sets the frequency and duration and powers a 1 microfarad smoothing Capacitor (FIG. 3.) before being boosted to 40 kilovolts Pulsed DC by a Transformer (FIG. 4.). Power is then boosted again by a 25 microfarad Capacitor (FIG. 5.) This provides increased power to the Spark Gap (FIG. 7.) which has an attached Permanent Magnet (FIG. 6.) providing quick quenching capability resulting in faster production of Electrostatic Electricity. Electrostatic Electric is composed of only voltage and no current. The frequency of the Electrostatic Electricity varies and is entered into the primary coils of (3) Frequency Transformers (FIG. 8), along with 110 60 Hz regular electricity from the inverter entered into the Frequency Transformers' secondary coils. The Frequency Transformers allow the two electrical forms to share electrical energy, with the result that regular electricity is generated. It produces 3 phase electricity powering the 3 phase drive motor (FIG. 9.). Two 12v Automotive Batteries (FIG. 10.) are connected to a battery Isolator (FIG. 11.) one battery charges while the other powers the inverter.

1. Method converts Electrostatic (static electricity) Electricity to usable AC electricity.

2. Method Generates Tesla's Electrostatic Electricity to power an Electric Vehicle.

3. Method powers an Electric Vehicle at no cost without fossil fuels or batteries.
